(19) United States
(12) Patent Application Publication
(10) Pub. No.: US 2005/0276078 A1
(43) Pub. Date: Dec. 15, 2005

(54) Lawn Lights Decorative Lighting System

(76) Inventor: Mark E. Halter, Washington, IN (US)

Correspondence Address: Dean E. McConnell;Sommer Barnard Attorneys, PC, One Indiana Square, Suite 3500, Indianapolis, IN, 46204, US

(21) Appl. No.: 10/908,799

(22) Filed: May 26, 2005

Related U.S. Application Data
(60) Provisional application No. 60/575,681, filed on May 28, 2004.

(51) Int. Cl. F21V 21/00

(52) U.S. Cl. 362/653

(57) ABSTRACT

A method for generating the decorative effect of randomly distributed points of light over a large area comprising proper deployment of a decorative lighting system (10) consisting of a light string assembly (11) composed of multiple light emitting components (23) which are spaced several feet apart and a plurality of light stakes (12) that are used to keep the light emitting components (23) suspended a short distance above the ground. The light stakes (12) are designed to utilize a more reliable wedging method instead of a clamping method to receive the light emitting components (23).

### CROSS-REFERENCE To RELATED APPLICATIONS

This application claims priority to and the benefit of U.S. provisional application Ser. No. 60/575,681 filed on May 28, 2004.

### BACKGROUND OF THE INVENTION

1. Field of the Invention

The present invention generally relates to the field of decorative lighting systems, and more particularly, to an outdoor holiday lawn decorative lighting system.

2. Related Art

Although there currently exist many outdoor lighting decorations that provide a means to decorate portions of homes or lawns, none yet exist that provide a means to economically, quickly, and easily cover their entire lawn or other very large areas with randomly distributed points of light. Many individuals use miniature light strings (e.g. U.S. Pat. No. 3,968,398), net lights (e.g. U.S. Pat. Nos. 5,934,793 and 6,657,398), icicle lights (e.g. U.S. Pat. Nos. 6,050,701 and 5,975,717), and lighted wire frames (e.g. U.S. Pat. Nos. 5,379,202 and D455,673) to outline and/or otherwise decorate isolated portions of their homes or lawns during holidays, primarily Christmas. Many individuals aspire to cover their entire lawn with miniature lights to generate an extraordinary nighttime display that blankets the area with points of light.

Some individuals attempt to generate this kind of display by covering their entire home or lawn with miniature light strings or net lights to blanket these areas with small points of light. However, they do so at an extraordinary expense of time, money, and effort. Such displays usually require dozens, if not hundreds, of miniature light strings or net lights. The existing prior art used is not designed to cover large areas in this manner. A significant investment must be made to purchase enough miniature light strings or net lights to cover large areas.

Depending on the complexity and size of the display, an excessive amount of time and effort is required to construct the display. These displays draw a great deal of electricity and therefore are expensive to operate and have a significantly higher fire and shock hazard than other light displays. Because displays constructed in this manner involve literally thousands of miniature lights, they are terribly difficult to repair and maintain. After the holiday is over, an excessive amount of time and effort is required to disassemble and store these displays. Even a minor snowfall will virtually cloak these displays unless a considerable amount of time and effort has been invested in some sort of mechanism to keep the lamps above the snowfall. During the daylight hours when they are not in use, these displays are readily visible and unattractive. Because the distance between lamps in existing miniature light strings or net lights is so short, it is exceedingly difficult to construct a display that appears like randomly distributed points of light instead of straight lines of lights.

Existing stakes that are used to suspend miniature lights a short distance above the ground surface are designed to ‘clamp’ onto the base of the miniature light. This requires the individual to force the base of the miniature light through a somewhat narrow opening into the clamping mechanism of the stake. If the stake is constructed of a malleable material like aluminum, the stress exacted on the stake by the individual when forcing the base of the miniature light into the clamping mechanism often deforms the clamping mechanism or stake, resulting in a stake that fails to maintain a firm grip on the miniature light. Conversely, if the stake is constructed of a stiff material like steel, it is often difficult for the individual to force the base of the miniature light into the clamping mechanism, resulting in fatigue of the hands and fingers. If the stake is constructed of a stiff material like plastic or resin, the stress exacted on the stake by the individual when forcing the base of the miniature light into the clamping mechanism often cracks the clamping mechanism or stake, resulting in a stake that cannot be used or repaired.

Even when these stakes are functioning properly, the miniature lights are easily dislodged from the stake when they are disturbed. This is often a factor when the individual has assembled the miniature light to the stake and attempts to shove the stake into the ground. While shoving the stake into the ground, the miniature light will fall out of the often weak clamping mechanism, forcing the individual to repeat the procedure using greater care. Even if the individual successfully assembles the miniature light to the stake and shoves the stake into the ground, the miniature lights are frequently disturbed by animals or other individuals and become easily dislodged from the stake, resulting in high maintenance for the display. Stakes that are designed to tightly clamp onto the miniature light base are often bulky, highly visible, and unattractive during the daylight hours. Such a stake would not meet the objective of this invention to provide a decoration that will remain virtually invisible during the daylight hours so that the decorated area does not appear unattractive during the time when the display is not in use.

Adams in U.S. Pat. No. 5,667,174 discloses a decorative light stake which suspends miniature lights a short distance above the ground surface. However, this stake uses a clamping mechanism to hold the light, is relatively visible during the daylight hours, and has other features that are of little use to the objectives of this invention. Similarly, Cox in U.S. Pat. No. 6,116,760 discloses a light stake which suspends miniature lights a short distance above the ground surface. This stake, as in Adams' stake, uses a clamping mechanism to hold the light and therefore suffers the problems described above. Therefore, there is a significant need for an improved method for suspending miniature lights a short distance above the ground surface or an improved stake.

As a result of the aforementioned problems, many individuals who desire to blanket their entire lawn with small points of decorative lights will not do so because of the extraordinary expense of time, money, and effort involved with using existing outdoor lighting decorations.

### SUMMARY OF THE INVENTION

The present invention discloses a decorative lighting system consisting of a light string assembly composed of multiple light emitting components spaced several feet apart and multiple light stakes that are used to keep the light emitting components above a moderate snowfall. The light stakes do not require the user to force the base of a bulb into a clip, which can deform the stake or clip. The light stakes permit the mounting of the bases by a wedging method rather than by a clamping method, which frequently discharges the base when it is disturbed. The objective of this invention is to provide individuals a decoration with which they can economically, safely, quickly, and easily cover their entire lawn or other very large areas with randomly distributed points of light resulting in an extraordinary nighttime display that blankets the area with small points of decorative light.

Accordingly, several objects and advantages of the present invention are:
to provide individuals a decoration with which they can economically, safely, quickly, and easily cover their entire lawn or other very large areas with randomly distributed points of light resulting in an extraordinary nighttime display that blankets the area with small points of decorative light;
to provide a decoration which will remain visible in the event of a minor to moderate snowfall;
to provide a decoration that will remain virtually invisible during the daylight hours so that the decorated area does not appear unattractive during the time when the display is not in use;
to provide a decoration that is very simple and easy to construct compared to the existing prior art that would be required to generate an equivalent display;
to provide a decoration that takes very little time to construct compared to the existing prior art that would be required to generate an equivalent display;
to provide a decoration that is much less expensive to manufacture than the existing prior art that would be required to generate an equivalent display;
to provide a decoration that is much less expensive to operate and maintain than the existing prior art that would be required to generate an equivalent display;
to provide a decoration that is composed of far fewer components than the existing prior art that would be required to generate an equivalent display;
to provide a decoration that has a significantly lower fire and shock hazard than the existing prior art that would be required to generate an equivalent display;
to provide a decoration that can be disassembled and stored much faster and with less effort than the existing prior art that would be required to generate an equivalent display;
to provide a decoration that will generate a random distribution of lights much easier than the existing prior art that would be required to generate an equivalent display;
to provide a stake that does not require the user to force the base of a bulb into a clip which can deform the stake or clip; and
to provide a stake that permits mounting of the base of a bulb by a wedging method rather than by a clamping method which frequently discharges the base if it is disturbed.

Other systems, methods, features and advantages of the invention will be, or will become apparent to one with skill in the art upon examination of the following figures and detailed description. It is intended that all such additional systems, methods, features and advantages be included within this description, be within the scope of the invention, and be protected by the following claims.

### BRIEF DESCRIPTION OF THE DRAWINGS

The components in the figures are not necessarily to scale, emphasis instead being placed upon illustrating the principles of the invention. Moreover, in the figures, like reference numerals designate corresponding parts throughout the different views.

FIG. 1 is a perspective view of a decorative lighting system in a typical end use of decorating a residential front lawn.

FIG. 2 is a perspective view depicting an embodiment of a light string assembly of the decorative lighting system.

FIG. 3 is a perspective view depicting one embodiment of a stake showing a mini light of an ornamental light string mounted in the loop.

FIG. 4 is a top view of a stake of the invention.

FIG. 5 is a top view depicting a cross sectional view of a stake with a base assembly inserted in a clip of the stake.

FIG. 6 is an electrical schematic for an embodiment of the light string assembly.

FIG. 7 is an electrical schematic for an alternate embodiment of the light string assembly.

### DETAILED DESCRIPTION OF THE PRESENTLY PREFERRED EMBODIMENTS

A preferred embodiment of the present invention is depicted in FIG. 1, which illustrates a lawn lights decorative lighting system 10 in a typical end use of decorating a residential front lawn. A light string assembly 11 may be deployed in the area being decorated and then is connected with light stakes 12. The light string assembly 11 may be laid out in an arc or semi-circle pattern since these patterns tend to best randomly distribute light emitting components 23 in the area being decorated. The desired decorative effect is best accomplished when the light emitting components 23 of the light string assembly 11 are randomly distributed several feet apart from each other (typically between 3 and 35 feet) in the area being decorated. The light stakes 12 are erected upright by shoving a base portion of the stake 12 into the ground by hand to the desired depth. The light emitting components 23 may then be connected with the light stakes 12.

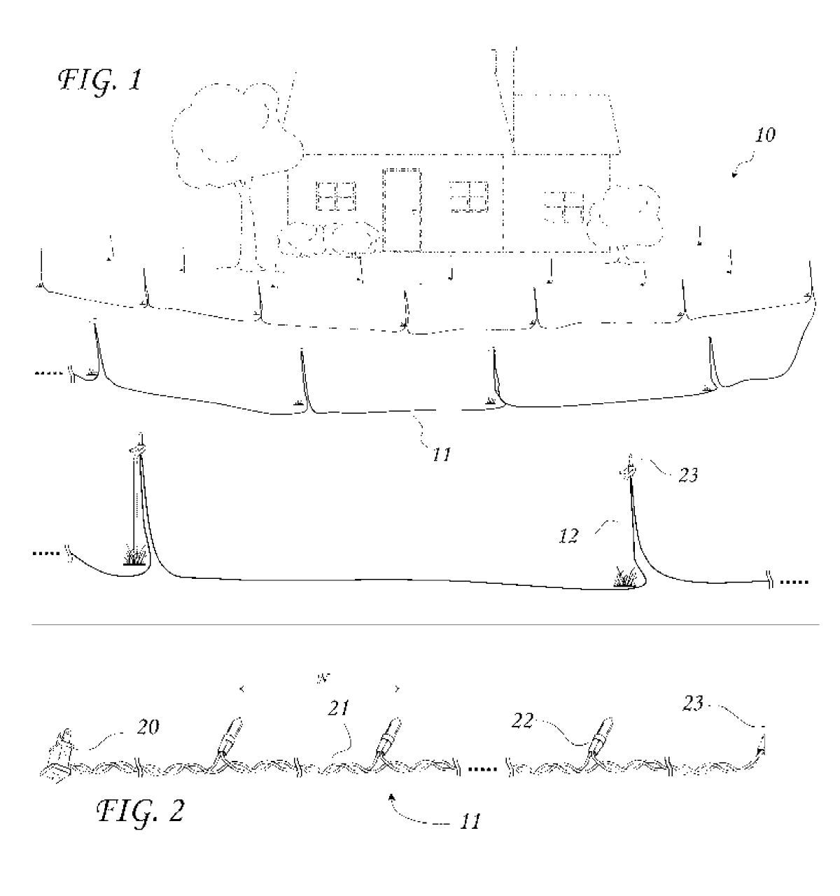

Referring now to FIG. 2, a preferred light string assembly 11 of the lawn lights decorating system 10 is depicted. The light string assembly 11 is a “string of lights”, which includes a plurality of light emitting components 23, each one being placed in one of a series of base assemblies 22 which are adapted to apply an electrical potential to the light emitting components 23 so as to cause them to emit light. Each light emitting component 23 is connected by electrically conducting wires 21 so that it is electrically in series and/or in parallel with the other, and having connectors contained in the base assembly 22 in the string of lights, which may be in electrical connection with a power source via a fused plug assembly 20, and thus each of the light emitting components 23.

The light string assembly 11 is comprised of light emitting components 23 that fit into base assemblies 22. In the preferred embodiment of the invention, the light emitting components 23 are shunted incandescent lamps commonly used in miniature Christmas tree lights strings, and the base assemblies 22 are those commonly used with shunted incandescent lamps. The wire 21 may connect the fused plug assembly 20 to the first base assembly 22 in the light string assembly 11, and connects each base assembly 22 to the next in the series. In the preferred embodiment of the invention, the fused plug assembly 20 is that commonly used in miniature Christmas tree light strings, and the wire 21 is twisted pair wire commonly used in miniature Christmas tree light strings. The fused plug assembly 20 contains current limiting components to limit the current being drawn through the plug to safe levels. Industry regulations dictate the acceptable specifications for the wire 21 for use in holiday lighting decorations. The preferred color for the wire 21 is a dark green.

The length of wire 21 between light emitting components 23 is unusually long (several feet) as specified in FIG. 2 by dimension N. Various values for dimension N (typically between 3 and 40 feet) are used to construct light string assemblies 11 of various overall lengths (usually hundreds of feet) that can be used to decorate various sizes of area. It has been determined that the maximum area that the lawn lights decorative lighting system 10 may comfortably decorate can be accurately estimated by the following equation: (Maximum coverage in square feet)=(N²*Q), where N is the length in feet of wire 21 used between each of the light emitting components 23 in the light string assembly 11, and Q is the total number of light emitting components 23 in the light string assembly 11. It has been determined that the minimum area that the lawn lights decorative lighting system 10 may comfortably decorate can be accurately estimated by the following equation: (Minimum coverage in square feet)=[N²*(Q^{1/2}−1)²], where N is the length in feet of wire 21 used between each of the light emitting components 23 in the light string assembly 11, and Q is the total number of light emitting components 23 in the light string assembly 11. It has been determined that the nominal area that the lawn lights decorative lighting system 10 may comfortably decorate can be accurately estimated by the following equation: (Nominal coverage in square feet)=[N²*( Q^{1/2}−(1−((2*E)/N))²], where N is the length in feet of wire 21 used between each of the light emitting components 23 in the light string assembly 11, Q is the total number of light emitting components 23 in the light string assembly 11, and E is the space in feet left between the edge of the area being decorated and the light string assembly 11.

As an example, if a light string assembly 11 is manufactured with 50 light emitting components 23 and with 10 feet of wire 21 between each of the light emitting components 23, the maximum coverage in square feet is computed to be 5000 square feet, the minimum coverage in square feet is computed to be 3686 square feet, and the nominal coverage in square feet is computed to be 4187 square feet. The preferred values for dimension N specified in FIG. 2 may be 5 feet (small), 10 feet (medium), and 15 feet (large). However, the specification for dimension N is not explicitly limited to these values and may be adjusted accordingly. If the value used for dimension N is allowed to fall below 3 feet, the objects and advantages of the present invention may begin to become less apparent.

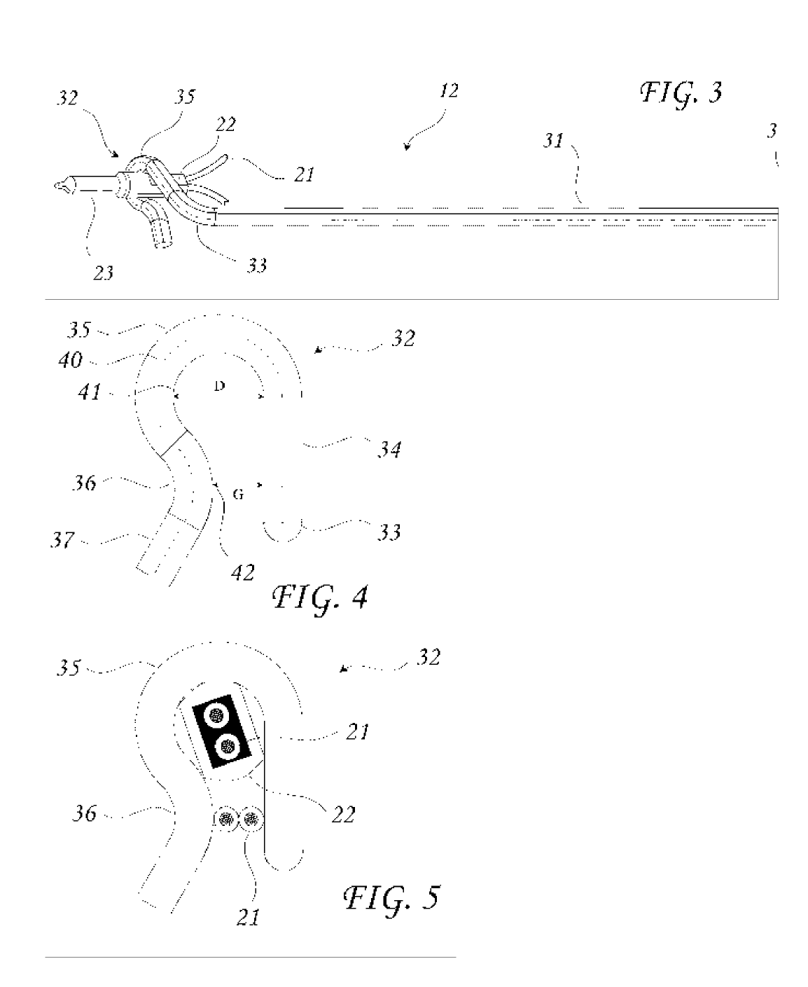

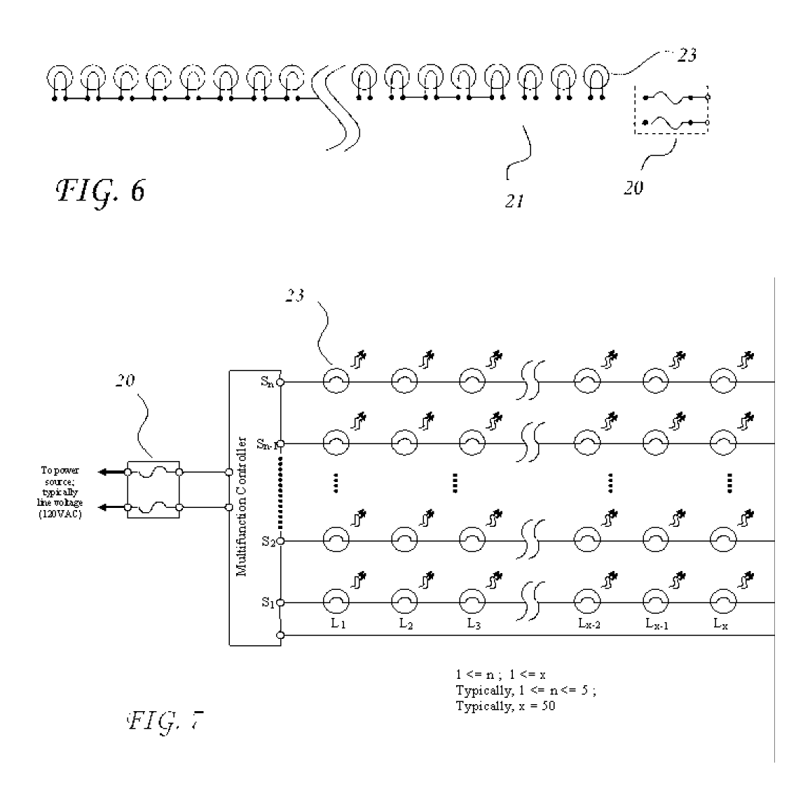

FIGS. 3, 4, and 5 depict a light stake 12 in accordance with the preferred embodiment of the present invention which includes an elongated shank 31 and a head 32. The head 32 includes a loop bend 35 sized for mounting therein the base assemblies 22 of the light string assembly 11. The light stake 12 is preferably formed of a single length of resilient wire bent to shape, but it may be appreciated that the light stake 12 may also be formed of two or more interconnected pieces and that it may be molded or shaped of synthetic resin, polypropylene or other resilient material.

In greater detail, the elongated shank 31 is elongated and while it may be made of any length to elevate the light emitting component 23 a desired distance above the ground, a shank length of 6 to 12 inches is a typical economical and reasonable length. The elongated shank 31 presents a ground-penetrating end 38 which may be sharpened to achieve acceptable penetration. The elongated shank 31 is most preferably formed of mild steel wire of a diameter of from about 2 to 4 mm, which provides sufficient ground penetrating ability, is resistant to ultraviolet rays, and is easily workable as well as resilient. The elongated shank 31 may be connected to the head 32 at shank bend 33 which orients the elongated shank 31 at approximately a 90 degree angle to head 32 as shown in FIG. 3.

The head 32 is preferably integrally formed with the elongated shank 31 of a continuous length of wire. The head 32 includes a stem 34 extending from shank bend 33 at a right angle to elongated shank 31, a loop bend 35 and a gap bend 36 which together with stem 34 form loop 40. The loop 40 defines a curved throat 41 which presents a greatest transverse dimension D, which is greater than the transverse dimension G of a gap 42 formed between the stem 34 and the gap bend 36. The transverse dimension G at gap 42 is less than the minimum width of the base assemblies 22 and greater than the width of the wire 21. A guide 37 extends from the gap bend 36 and diverges from stem 34.

Referring now to FIG. 5, a cross section of the preferred embodiment of the head 32 with a base assembly 22 is depicted. The head 32 of the light stake 12 consists of a loop bend 35 sized for mounting therein the base assemblies 22 of the light string assembly 11. The inner radius of this loop bend 35 is large enough to accommodate a single base assembly 22, yet small enough that the base assembly 22 will wedge in loop 40.

In use, the light stake 12 hereof is sufficiently economical to make thereby allowing a number of the stakes 12 to be used to hold the base assemblies 22 of the light string assembly 11. As shown in FIG. 3, a base assembly 22 may be received in loop 40 by elevating the entire base assembly 22 over the head 32, sliding the wire 21 that is exiting the base assembly 22 through gap 42 into loop 40, rotating base assembly 22 such that the bottom of the base assembly 22 will fit into loop 40, and inserting the bottom of base assembly 22 into loop 40 until it has sufficiently been wedged in loop 40. The guide 37 guides the wire 21 into the loop 40.

It may be appreciated that the structure of the light stake 12 uniquely permits mounting of base assemblies 22 by a wedging method rather than by a clamping method. Thus, light stake 12 hereof uniquely provides an improved method of mounting base assemblies 22 by eliminating the need to force base assembly 22 through gap 42 into loop 40, which can cause deformation of the head 32 rendering it incapable of holding the base assembly 22. It may also be appreciated that the structure of the light stake 12 hereof uniquely provides an improved method of holding base assemblies 22 by utilizing a wedging method rather than a clamping method which frequently discharges the base assembly 22 from loop 40 when the base assembly 22 is disturbed. By using a wedging method, it is far more difficult for the base assembly 22 to become discharged from loop 40, because in order to do so, enough upward force to lift the base assembly 22 up and out of the loop 40 must be imparted. In using a clamping method, it is much easier to dislodge the base assembly 22 from loop 40, because the force required to do so can be imparted in almost any direction, and this frequently occurs any time the base assembly 22 is disturbed.

Once the base assembly 22 is mounted in the head 32, the user may position the light stake 12 in the desired location and insert the end 38 of the elongated shank 31 into the ground a sufficient distance to support the light stake 12 and any base assembly 22 mounted thereon. The amount of penetration to accomplish this function will vary according to temperature, moisture, soil type, and vegetation, and the distance the base assembly 22 should be elevated above the ground will be a matter of personal preference.

### OPERATION OF INVENTION

Referring to FIG. 1, which illustrates a lawn lights decorative lighting system 10 in a typical end use of decorating a residential front lawn, the user is instructed to deploy a light string assembly 11 in the area being decorated and assemble the base assemblies 22 to the light stakes 12. The user is instructed to lay out the light string assembly 11 in any pattern that they choose in the area that they wish to decorate. A random pattern of arcs or semi-circles is highly recommended because these patterns tend to best randomly distribute light emitting components 23 in the area being decorated. The user is instructed to avoid straight-line patterns and to make attempts to distribute the light emitting components 23 equal distances away from each other. For instance, if the spacing between light emitting components 23 on the light string assembly 11 is 17 feet, then the user is instructed to attempt to keep all light emitting components 23 roughly 17 feet away from each other in order to efficiently cover the targeted area. Failure to follow this step will not cause adverse effects to the display, but the lawn lights decorative lighting system 10 may fail to accurately meet its specified coverage. The user is also advised to plan the pattern such that the fused plug assembly 20 will be conveniently positioned near its power source. It is recommended that the user start their pattern at the power source and to work outwardly from that point.

Once the light string assembly 11 has been completely deployed in the desired pattern, the user is then instructed to briefly plug the light string assembly 11 into a power source and verify that all light emitting components 23 are functioning properly and emitting light. Once this has been verified, the user is instructed to stake a light stake 12 next to each of the base assemblies 22, elevate the entire base assembly 22 over the head 32, slide the wire 21 that is exiting the base assembly 22 through gap 42 into loop 40, rotate base assembly 22 such that the bottom of the base assembly 22 will fit into loop 40, and insert the bottom of base assembly 22 into loop 40 until it has sufficiently been wedged in loop 40. The light stakes 12 will hold the base assembly 22 several inches above the ground and above a moderate snowfall. They also make the light emitted by the light emitting components 23 more visible and uniform. A rubber band or clamping device may be provided that will allow the user to draw the wire 21 tightly to the base of the light stakes 12 to improve the aesthetics of the installed system at the user's option.

To remove the lawn lights decorative lighting system 10 and store it, the procedure is simply reversed. First, the user is encouraged to replace or repair any light emitting components 23 before removing the lawn lights decorative lighting system 10 so that it will work properly in subsequent uses. The user is then instructed to unplug the light string assembly 11 from its power source. Next, the user must remove the base assemblies 22 from the light stakes 12 by simply lifting the base assembly 22 up and out of the loop 40 and sliding the wire 21 that is exiting the base assembly 22 out of loop 40 through gap 42. The user then collects all of the light stakes 12 by pulling them back up out of the ground. Finally, the user is instructed to collect the light string assembly 11, usually onto some sort of provided spool assembly. If a spool assembly is provided, it is recommended that the user wind the light string assembly 11 onto the spool starting with the end opposite the fused plug assembly 20 so that the fused plug assembly 20 is readily accessible during subsequent deployments of the lawn lights decorative lighting system 10. Once the light string assembly 11 has been collected, the lawn lights decorative lighting system 10 can then be stored at the user's discretion.

### DESCRIPTION—ALTERNATE EMBODIMENTS

There are many variants of the preferred embodiment of the lawn lights decorative lighting system 10 that will offer additional features to the display. Referring now to FIG. 4, the stem 34 could be replaced with another gap bend 36 which would assist funneling through gap 42.

Referring now to FIG. 2, a GFCI (Ground Fault Circuit Interrupter) plug could be used in place of fused plug assembly 20. This would help prevent the burnout of light emitting components 23. In practice, it has been discovered that if the light emitting components 23 are shunted incandescent lamps commonly used in holiday lighting products and the invention is used in a wet environment, the lamps tend to burn out because of a short to ground. It is a labor-intensive process to replace all light emitting components 23 in this event. A GFCI plug similar to those used on modern hairdryers may be used to prevent lamp burnout.

There are several options available for use as the light emitting components 23 in the light string assembly 11. The preferred embodiment uses shunted incandescent lamps, which are commonly used in holiday lighting products. However, LEDs (Light Emitting Diodes) may be preferable, since they are safer to operate, consume less energy, and have a longer lifespan. LEDs are becoming more and more prevalent in holiday lighting products as the LED industry continues to increase their intensity and lower their cost. Eventually, the intensity of LEDs will become sufficient enough and the LEDs economical enough to use as the light emitting components 23 in the light string assembly 11. Another option for the light emitting components 23 are special bulbs commonly referred to as “twinkle lights”. These bulbs are very similar to shunted incandescent lamps, except that they are capable of periodically turning themselves on and off. This is accomplished by a heated filament within the bulb, and gives the illusion of a ‘flashing’ effect. These are often used in Christmas light strings used to decorate Christmas trees. Using these as the light emitting components 23 in the light string assembly 11 can produce an extraordinary “twinkling” effect over the area being decorated. Another option for the light emitting components 23 is colored lamps or LEDs, such as red, green, blue, white, etc. Use of colored shunted incandescent lamps or LEDs can produce unique desirable effects.

There are some options available for use as the wire 21 in the light string assembly 11. The preferred embodiment uses a twisted pair wire commonly used in holiday lighting products. Twisted pair wire appears to give the best results for lying on the ground. However, other wire may be used.

Referring now to FIG. 7, a multifunction controller can be introduced into the design. This type of feature is commonly found in other similar holiday lighting products. When this alternate embodiment is used, several individual light string assemblies 11 are combined into a single physical light string. The power to each individual light string assembly 11 is controlled and regulated by the multifunction controller. This embodiment offers many different lighting functions, such as chase sequences, fading effects, random patterns, etc. The multifunction controller's circuitry can be programmed to provide an almost endless list of lighting functions.

A step down transformer can be introduced into the design. A step down transformer may improve the safety and the performance of the invention. By stepping the voltage down from 120 VAC to 24 VAC, for instance, the working voltage is reduced to a level that offers far less of a shock hazard. In addition, when shunted lamps are used as the light emitting components 23 in the light string assembly 11, far fewer lamp burnouts are encountered in wet environments because the light string assembly 11 is far less likely to short out at lower voltages than it is at 120 VAC. However, there are a few drawbacks to introducing a step down transformer into the design. First of all, although the voltage is significantly reduced, the current required is correspondingly increased. This increases the risk of a fire hazard. Secondly, the voltage applied to the light emitting components 23 is significantly reduced by resistive line losses in the wire 21, and this adversely affects the intensity of the light emitting components 23 near the end of the light string assembly 11.

The present invention provides individuals a decoration with which they can economically, safely, quickly, and easily cover their entire lawn or other very large area with randomly distributed points of light resulting in an extraordinary nighttime display that blankets the area with small points of decorative light. The present invention provides a decoration that will remain visible even in the event of a moderate snowfall, and will be virtually invisible during the daylight hours when the decoration is not in use. When compared to the existing prior art that is required to generate a similar display, the reader will see that the present invention 1)is much simpler to use and easier to set up; 2) takes considerably less time to set up; 3) is much less expensive to manufacture and purchase; is much less expensive to operate and maintain; 4) is composed of far fewer components; has a significantly lower fire and shock hazard; 5)can be disassembled and stored much faster and with far less effort; and 6) will generate a random distribution of lights much easier.

In addition, the light stakes 12 of the present invention provide a more reliable method of suspending decorative lighting above the ground as well as eliminate the features that cause the user to suffer fatigue of the hands and fingers. The light stakes 12 of the present invention eliminate features that can cause deformation of or damage to the stake.

Although preferred forms of the invention have been described above, it is to be recognized that such disclosure is by way of illustration only, and should not be utilized in a limiting sense in interpreting the scope of the present invention. Obvious modifications to the exemplary embodiments, as hereinabove set forth, could be readily made by those skilled in the art without departing from the spirit and scope of the present invention. For example, a more decorative stake could be utilized in place of the light stake 12 described above. In addition, LEDs or twinkle lights could be utilized instead of shunted incandescent lamps for the light emitting components 23.

While the present invention has been described with reference to specific exemplary embodiments, it will be evident that various modifications and changes may be made to these embodiments without departing from the broader spirit and scope of the invention as set forth in the claims. Accordingly, the specification and drawings are to be regarded in an illustrative rather than a restrictive sense.

1. A decorative lighting system for a lawn, comprising:
a plurality of lights interconnected to each other by a conductive wire, wherein each of said plurality of lights is positioned in a base assembly;
a plurality of light stakes, wherein each said light stake includes a ground penetrating end and a head; and
wherein said base assembly of each of said plurality of lights is positioned in said head of said light stake, wherein said ground penetrating end of said light stake is placed in a ground engaging position such that each of said plurality of lights is located a predetermined distance above said ground engaging position.

2. The decorative lighting system of claim 1, wherein each of said plurality of lights is spaced apart from one another at least a distance of approximately three feet.

3. The decorative lighting system claim 1, wherein said light stake includes an elongated shank portion extending upwardly from said ground penetrating end towards said head, wherein each said head comprises a shank bend connected with said elongated shank portion, a stem portion connected with said shank bend, a loop bend connected with said stem portion, a gap bend connected with said loop bend, and a guide connected with said gap bend.

4. The decorative light system of claim 3, wherein said base assembly of said plurality of lights is removably wedged between said stem, said loop bend, and said gap bend of said light stake.

5. The decorative light system of claim 4, wherein said shank bend positions said head at approximately a 90° angle in relation to said elongated shank portion.

6. The decorative lighting system of claim 1, further comprising a multifunction controller connected with said plurality of lights for controlling illumination of said plurality of lights.

7. A method of forming an illuminated lawn display, comprising the steps of:
laying a strand of lights out in a pattern on a designated coverage area of a lawn, wherein said strand of lights includes a plurality of base assemblies connected with a conductive wire, wherein a light emitting device is connected with said base assembly;
wedging each said base assembly in a head of a light stake; and
placing a ground penetrating end of said light stake in an upright position in a portion of ground such that said light emitting device is positioned a predetermined distance above the portion of ground.

8. The method of claim 7, wherein each of said light emitting devices is spaced apart from each other at least a distance of approximately five feet.

9. The method of claim 7, wherein said light stake includes an elongated shank portion extending upwardly from said ground penetrating end towards said head, wherein each said head comprises a shank bend connected with said elongated shank portion, a stem portion connected with said shank bend, a loop bend connected with said stem portion, a gap bend connected with said loop bend, and a guide connected with said gap bend.

10. The method of claim 9, wherein said base assembly of said plurality of lights is removably wedged between said stem, said loop bend, and said gap bend of said light stake.

11. The method of claim 10, wherein said shank bend positions said head at approximately a 90° angle in relation to said elongated shank portion.

12. The method of claim 7, further comprising the step of controlling illumination of said plurality of light emitting devices with a multifunction controller.

13. A decorative lighting system for a lawn, comprising:
a plurality of lights interconnected to each other by a conductive wire, wherein each of said plurality of lights is positioned in a base assembly, wherein each of said plurality of lights is spaced apart from one another at least a distance of approximately three feet;
a plurality of light stakes, wherein each said light stake includes a ground penetrating end and a head, wherein said light stake includes an elongated shank portion extending upwardly from said ground penetrating end towards said head, wherein each said head comprises a shank bend connected with said elongated shank portion, a stem portion connected with said shank bend, a loop bend connected with said stem portion, a gap bend connected with said loop bend, and a guide connected with said gap bend; and
wherein said base assembly of each of said plurality of lights is removably wedged between said stem, said loop bend, and said gap bend of said light stake, wherein said ground penetrating end of said light stake is placed in a ground position such that each of said plurality of lights is located a predetermined distance above said ground position.

14. The decorative lighting system of claim 1 3, wherein each of said light emitting devices is spaced apart from each other at least a distance of approximately ten feet.
